(19) United States
(12) Patent Application Publication
(10) Pub. No.: US 2017/0085728 A1
(43) Pub. Date: Mar. 23, 2017

(54) INFORMATION PROCESSING DEVICE, METHOD, AND MEDIUM

(71) Applicant: PFU LIMITED, Kahoku-shi (JP)

(72) Inventors: Osamu Miyakawa, Kahoku-shi (JP); Hitoshi Matsuo, Kahoku-shi (JP); Shinsuke Hamano, Kahoku-shi (JP)

(73) Assignee: PFU LIMITED, Kahoku-shi (JP)

(21) Appl. No.: 14/989,865

(22) Filed: Jan. 7, 2016

(30) Foreign Application Priority Data
Sep. 18, 2015 (JP) 2015-185624

(51) Int. Cl. H04N 1/00; H04N 1/327; H04L 29/08

(52) U.S. Cl. CPC H04N 1/00244; H04L 67/141; H04L 67/142; H04N 1/32765; H04N 1/32786; H04N 2201/0094

(57) ABSTRACT

A scanner includes: a first session managing unit which establishes a session to be established for communication, related to an image data acquisition/saving process, with a server before an instruction by a user related to the image data acquisition/saving process is accepted; and a second session managing unit which establishes a session to be established for communication, related to an existence confirmation process, with the server at the same time as or after start of execution of the existence confirmation process.

### CROSS-REFERENCE TO RELATED APPLICATION

This application is based upon and claims the benefit of priority of the prior Japanese Patent Application No. JP2015-185624, filed on Sep. 18, 2015, the entire contents of which are incorporated herein by reference.

### FIELD

The present disclosure relates to a technique for managing communication by an information processing device.

### BACKGROUND

Conventionally, an information processing device is proposed which is capable of communicating with a specific firmware information transmitting device and a firmware providing server connected to a network and which continuously or intermittently maintains a session with the specific firmware information transmitting device (refer to Japanese Patent Application Publication No. 2014-179021).

In addition, a technique is proposed which, when a communication session between a terminal and a web server is interrupted, generates session state information indicating a state of the interrupted communication session and registers the session state information in session state retaining means and, at the same time, the web server forcibly terminates the interrupted session and releases an internal resource related to the interrupted session (refer to Japanese Patent Application Publication No. 2006-309595).

Furthermore, a technique is proposed for determining a service communication method and a service communication path in order to establish a communication path suitable for a service in a cloud-connected multifunction machine (refer to Japanese Patent Application Publication No. 2012-037944).

### SUMMARY

An example of the present disclosure is an information processing device including: a first session managing unit which establishes a session to be established for communication, related to a first process, with a server before an instruction by a user related to the first process is accepted; and second session managing unit which establishes a session to be established for communication, related to a second process, with the server at the same time as or after start of execution of the second process.

The present disclosure may be viewed as an information processing device, a system, a method that is executed by a computer, and a program to be executed by a computer. In addition, the present disclosure may be viewed as a recording of such a program on a recording medium that is readable by a device such as a computer, a machine, or the like. In this case, a recording medium that is readable by a computer or the like refers to a recording medium which stores information such as data and programs by an electric action, a magnetic action, an optical action, a mechanical action, or a chemical action and which can be read by a computer or the like.

### BRIEF DESCRIPTION OF THE DRAWINGS

FIG. 1 is a schematic diagram showing a configuration of a system according to an embodiment;

FIG. 2 is a diagram showing a hardware configuration of a scanner according to an embodiment;

FIG. 3 is a diagram schematically showing a functional configuration of a system according to an embodiment;

FIG. 4 is a flow chart showing an outline of a flow of an existence confirmation process (corresponding to a second process) according to an embodiment;

FIG. 5 is flow chart A showing an outline of a flow of an image data acquisition/saving process (corresponding to a first process) according to an embodiment;

FIG. 6 is flow chart B showing an outline of a flow of an image data acquisition/saving process (corresponding to a first process) according to an embodiment;

FIG. 7 is a diagram showing time related to establishing sessions and transmitting and receiving data when the image data acquisition/saving process according to an embodiment is executed; and

FIG. 8 is a diagram showing time related to establishing sessions and transmitting and receiving data when a conventional image data acquisition/saving process is executed.

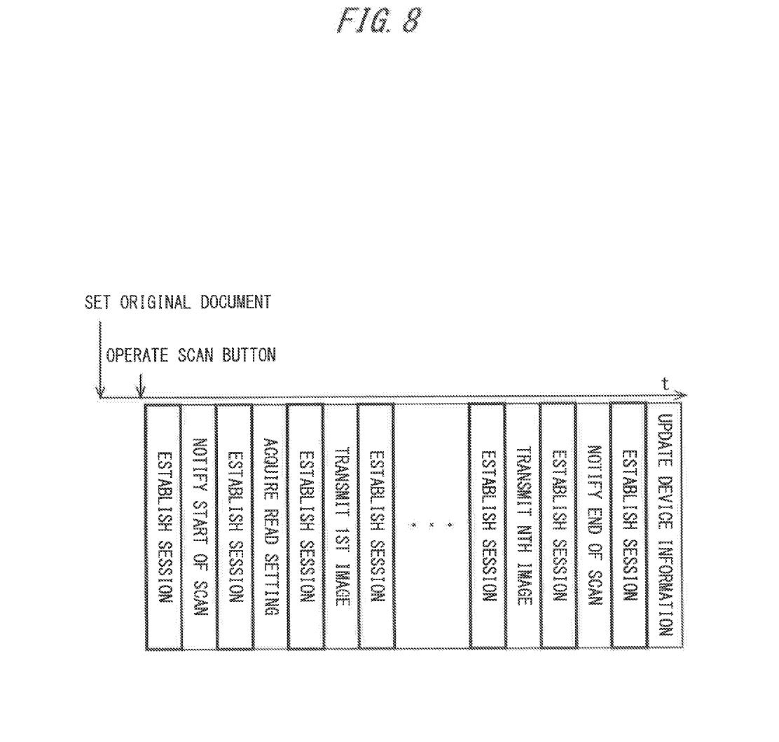

### DESCRIPTION OF EMBODIMENTS

Hereinafter, an embodiment of an information processing device, a system, a method, and a program according to the present disclosure will be described with reference to the drawings. However, it should be noted that the embodiment described below merely exemplifies the present disclosure and is not intended to limit an information processing device, a system, a method, and a program according to the present disclosure to the specific configurations described below. When implementing the present disclosure, a specific configuration may be adopted as appropriate in accordance with each embodiment. In addition, various improvements and modification may be made to the present disclosure.

As the present embodiment, an embodiment in which an information processing device, a system, a method, and a program according to the present disclosure are implemented in a system interlocked with a scanner will be described. However, an information processing device, a system, a method, and a program according to the present disclosure can be widely used with respect to techniques for managing communication by an information processing device. Accordingly, objects of application of the present disclosure are not limited to the examples described in the present embodiment.

<Configuration of System>

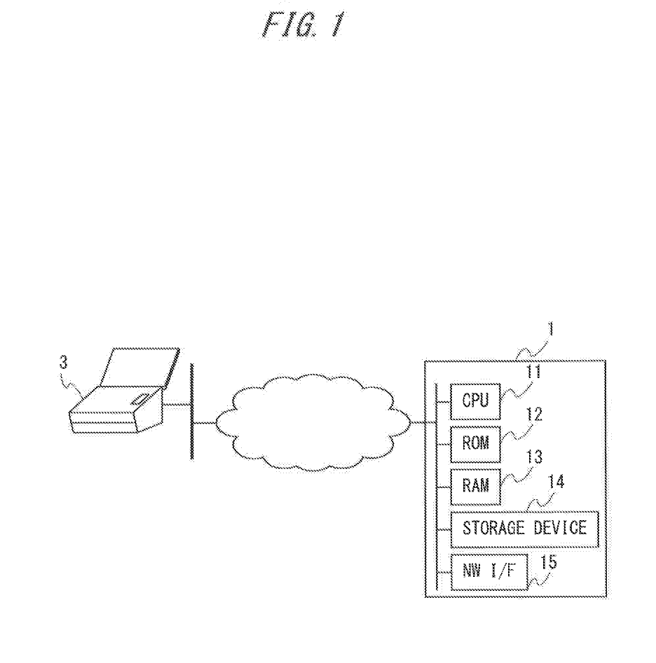

FIG. 1 is a schematic diagram showing a configuration of a system according to the present embodiment. The system according to the present embodiment includes a scanner 3 and an image data processing server 1 which are connected via a network such as the Internet or a wide area network.

The image data processing server 1 is a computer including a central processing unit (CPU) 11, a read only memory (ROM) 12, a random access memory (RAM) 13, a storage device 14 that is an electrically erasable and programmable read only memory (EEPROM), a hard disk drive (HDD), or the like, a communicating unit 15, and the like. Moreover, while the image data processing server 1 is shown to be a computer housed in a single case for the sake of simplicity, in the present embodiment, the image data processing server 1 provides an image data processing service to a user by having a part of or all of its functions executed by a device installed at a remote location or by a plurality of devices installed in a distributed manner through the use of cloud technology or the like. However, the configuration of the image data processing server 1 is not limited to the configuration exemplified in the present embodiment.

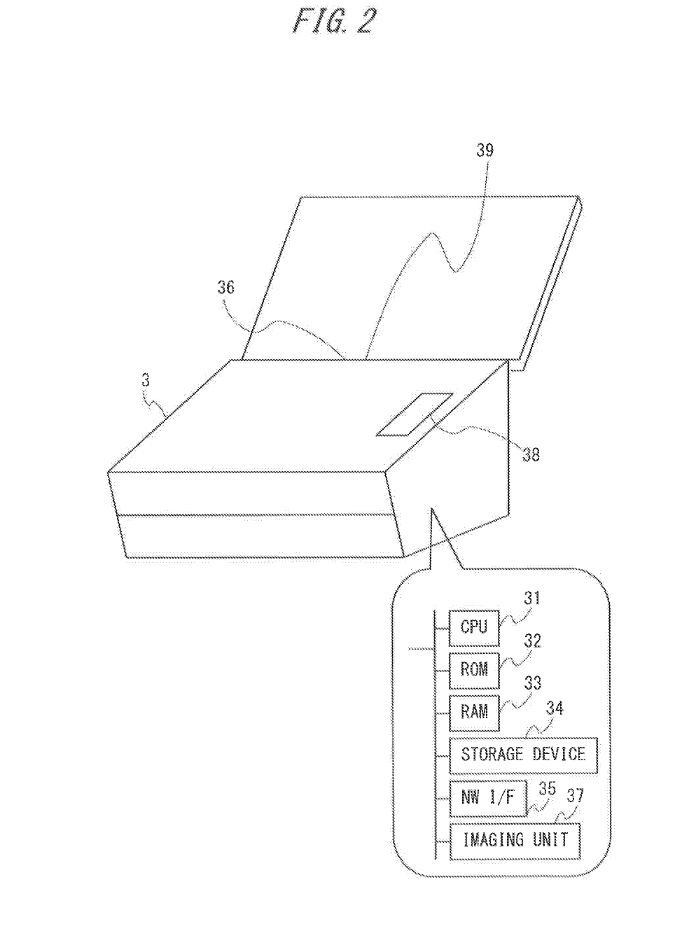

FIG. 2 is a diagram showing a hardware configuration of the scanner 3 according to the present embodiment. The scanner 3 is a device which acquires image data by capturing an image of an original document such as a document, a name card, a receipt, and a photograph/illustration set by the user and is an imaging device including a sheet feeder 36 that feeds an original document to an imaging unit 37, the imaging unit 37, a scan button 38, a CPU 31, a ROM 32, a RAM 33, a storage device 34, a communicating unit 35, and the like. Moreover, while a scanner 3 adopting an image system in which images of an original document set in the sheet feeder 36 are captured while the original document is being automatically fed is exemplified in the present embodiment, the imaging system of a scanner is not limited to such a system. For example, a scanner of a type in which an image of an original document set at a reading position by the user may be used. In addition, while an example of using the scanner 3 as an imaging device used in the present system is described in the present embodiment, the imaging device used in the present system is not limited to a scanner. For example, a camera may be adopted as an imaging device.

The scanner 3 according to the present embodiment is capable of connecting to a wireless LAN due to being provided with a wireless communication function. In addition, while the scanner 3 according to the present embodiment includes a scan button 38 that is pressed or touched by the user to instruct the scanner 3 to capture an image, the scanner 3 does not include a user interface that enables character input/output and item selection such as a touch panel display and a keyboard nor does it include a web browser function and a server function. However, communicating means, hardware configuration, and the like of a scanner capable of adopting the method according to the present embodiment are not limited to those exemplified in the present embodiment.

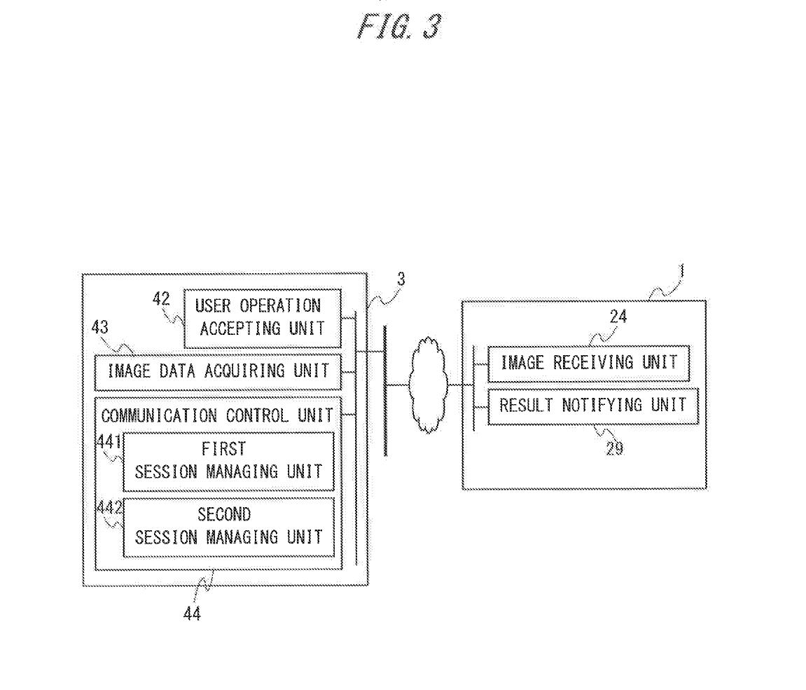

FIG. 3 is a diagram schematically showing a functional configuration of the system according to the present embodiment. As respective hardware included in the image data processing server 1 are controlled by having a program recorded in the storage device 14 read by the RAM 13 and executed by the CPU 11, the image data processing server 1 functions as a device that includes an image receiving unit 24 and a result notifying unit 29. Moreover, in the present embodiment, the respective functions of the image data processing server 1 are executed by the CPU 11 that is a general purpose processor. Alternatively, a part of or all of the functions may be executed by one or a plurality of dedicated processors.

The image receiving unit 24 receives, via the network, image data which is acquired by and transmitted from the user-authenticated scanner 3.

The result notifying unit 29 performs a result notification to notify the user of a result (completion, failure, and the like) of processing of received image data.

As respective hardware included in the scanner 3 are controlled by having a program recorded in the storage device 34 read by the RAM 33 and executed by the CPU 31, the scanner 3 functions as a device that includes a user operation accepting unit 42, an image data acquiring unit 43, and a communication control unit 44. Moreover, in the present embodiment, the respective functions of the scanner 3 are executed by the CPU 31 that is a general purpose processor. Alternatively, a part of or all of the functions may be executed by one or a plurality of dedicated processors.

The user operation accepting unit 42 accepts a prescribed user operation. In the present embodiment, as the prescribed user operation, pressing or touching the scan button 38 provided on the scanner 3 is accepted as a user operation for collectively instructing a series of processes from starting a scan to transmitting data to the image data processing server 1. However, the prescribed user operation that triggers a scan to start is not limited to the example according to the present disclosure.

When the prescribed user operation is accepted by the user operation accepting unit 42, the image data acquiring unit 43 acquires image data by capturing an image of an object. Specifically, when an operation of the scan button 38 is accepted by the user operation accepting unit 42, the image data acquiring unit 43 of the scanner 3 according to the present embodiment acquires image data of an original document by controlling the sheet feeder 36 to send the original document to the imaging unit 37 and then controlling the imaging unit 37 to capture an image of the original document.

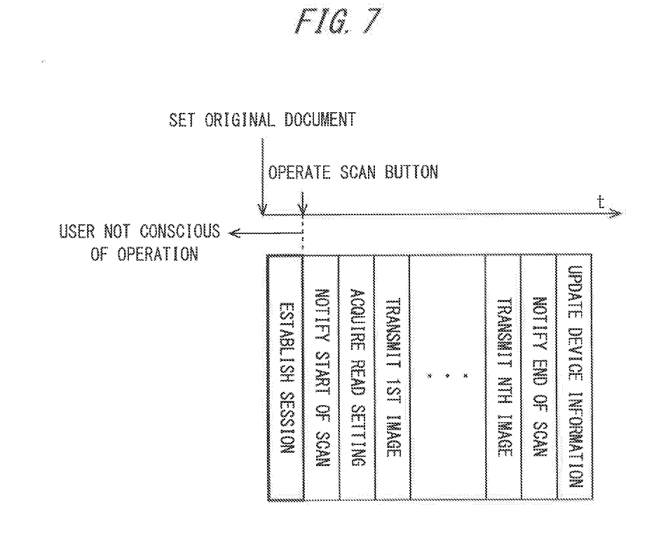

The communication control unit 44 controls communication between the scanner 3 and the image data processing server 1 in order to transmit image data acquired by the image data acquiring unit 43 to an account of the user at the server 1. The communication performed by the communication control unit 44 to the server 1 for this purpose includes notification of a start of a scan, acquisition of a read setting of the scanner 3, transmission of image data, notification of an end of the scan, and update of device information (refer to FIG. 7).

In addition, communication control by the communication control unit 44 includes management of communication sessions between the scanner 3 and the server 1. The scanner 3 according to the present embodiment performs session management using whichever management unit is appropriate between a first session managing unit 441 and a second session managing unit 442 according to a type of a process requiring a communication session to be established with the server 1.

The first session managing unit 441 establishes a session to be established for communication, related to a first process (for example, an image data acquisition/saving process to be described later), with the server 1 before an instruction by the user related to the first process is accepted and upon detecting that preparation for the first process is being performed by the user. In this case, the first process includes transmission and reception of information of a plurality of different types for completing the first process. In addition, the first session managing unit 441 maintains the established session while a plurality of communications for transmitting and receiving the information of a plurality of different types are being performed intermittently. Moreover, in the present embodiment, an image data acquisition/saving process by the scanner 3 is classified as the first process.

The second session managing unit 442 establishes a session to be established for communication, related to a second process (for example, an existence confirmation process to be described later), with the server 1 at the same time as or after start of execution of the second process. In addition, the second session managing unit 442 discards a session for communication related to the second process at each end of communication included in the second process or at each lapse of time set for each established session. Moreover, in the present embodiment, an existence confirmation (for example, keep-alive) process of the server 1 which is regularly executing during power-on of the scanner 3 is classified as the second process.

<Flow of Processes>

Next, a flow of processes executed by the system according to the present embodiment will be described. It is to be understood that specific contents and a specific sequence of processes described below merely represent one example of implementing the present disclosure. Specific contents and sequences of the processes may be appropriately selected in accordance with embodiments of the present disclosure.

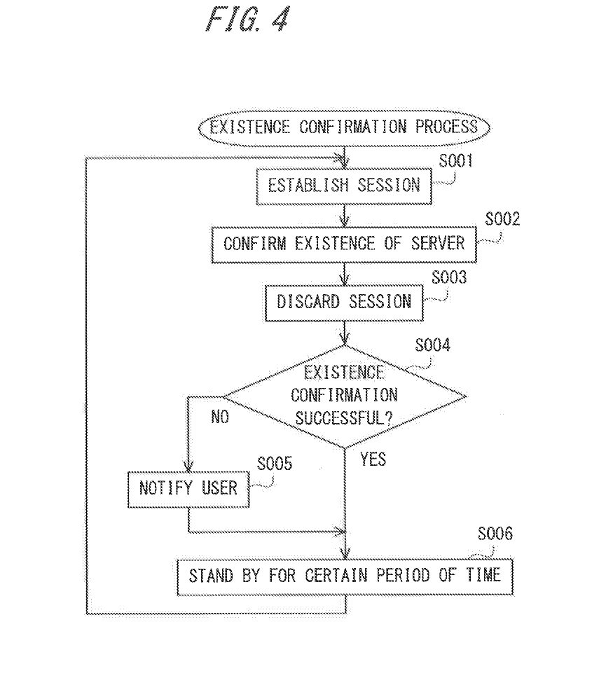

FIG. 4 is a flow chart showing an outline of a flow of an existence confirmation process (corresponding to a second process) according to the present embodiment. Execution of the process shown in the present flow chart is triggered by power-on of the scanner 3.

In step S001, a communication session is established. The second session managing unit 442 performs communication for starting a TCP connection or an SSL/TLS session (hereinafter, simply referred to as a “session”) to the server 1 and establishes a session with the server 1. However, the term “session” as used in the present disclosure refers to a session used to manage a series of communications on a session layer/transport layer and is not limited to a TCP connection or an SSL/TLS session exemplified above. Subsequently, the process proceeds to step S002.

In step S002, existence of the server 1 is confirmed. The communication control unit 44 confirms that a connection with the server 1 is normally performed by transmitting an existence confirmation message to the server 1 and receiving a response message transmitted from the server 1 having normally received the existence confirmation message. Subsequently, the process proceeds to step S003.

In step S003, the session is discarded. The second session managing unit 442 discards the session once the existence of the server 1 is confirmed. Subsequently, the process proceeds to step S004.

In steps S004 and S005, a notification is made to the user when existence confirmation of the server 1 fails. When a response message from the server 1 is not received even after a lapse of a prescribed period of time or more or when a message notifying an abnormality is received from the server 1 during the existence confirmation of the server 1 in step S002 (NO in step S004), the scanner 3 notifies the user that a connection with the server 1 is not normally performed using an LED (not illustrated) or the like provided on the scanner 3 (step S005). Subsequently, the process proceeds to step S006.

In step S006, a stand-by process is performed until a certain period of time lapses. The scanner 3 waits for the lapse of a certain period of time (in the present embodiment, 30 seconds) as the stand-by process before performing a next existence confirmation of the server 1. In other words, in the present embodiment, an existence confirmation of the server 1 is performed every certain period of time and a notification is made to the user when an abnormality occurs.

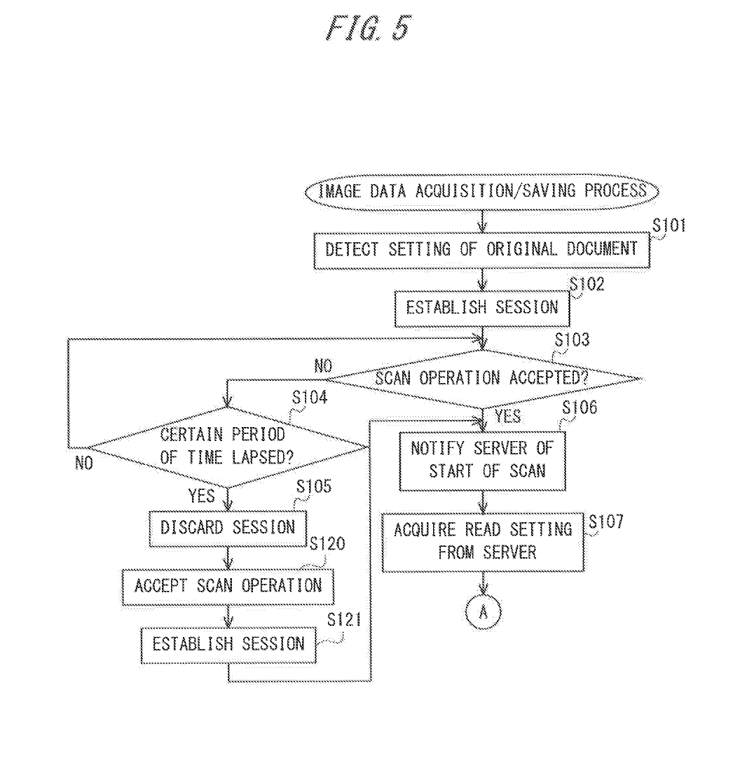

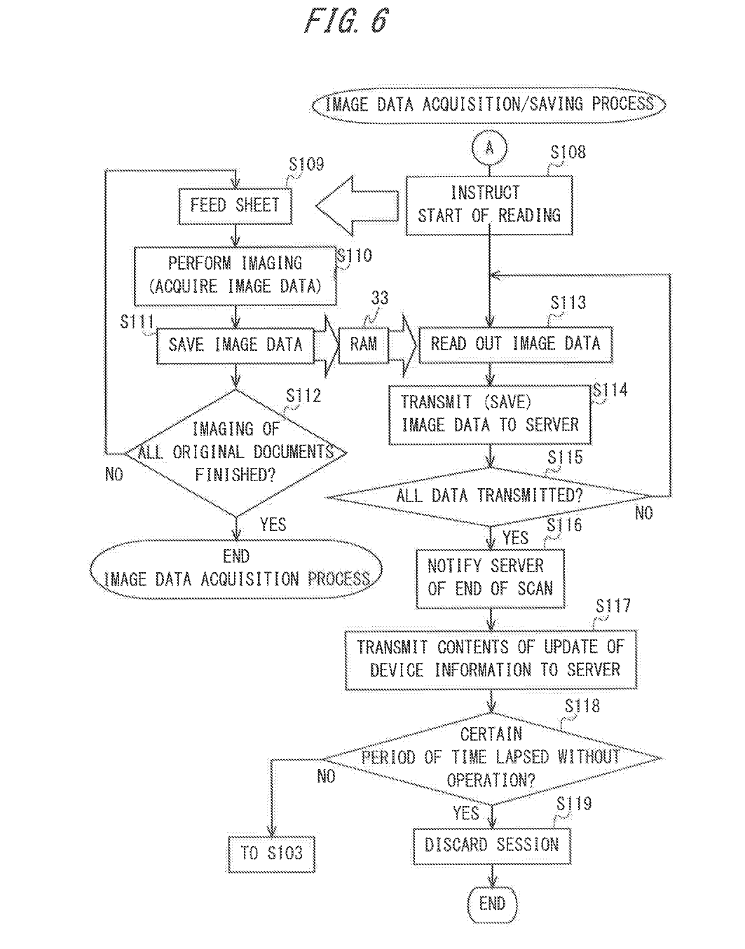

FIGS. 5 and 6 are flow charts showing an outline of a flow of an image data acquisition/saving process (corresponding to a first process) according to the present embodiment. Execution of the process shown in the present flow charts is triggered by the user setting an original document on the sheet feeder 36 in the scanner 3.

In steps S101 and S102, setting of an original document is detected and a communication session is established. When the original document sensor 39 detects that the original document has been set on the sheet feeder 36 (step S101), the first session managing unit 441 performs communication for starting a session (a TCP connection, an SSL/TLS session, or the like) to the server 1 and establishes a session with the server 1 (step S102). Subsequently, the process proceeds to step S103.

In steps S103 to S105, an operation of the scan button 38 by the user is awaited and the session is discarded when an operation is not performed. When an operation of the scan button 38 is accepted by the user operation accepting unit 42 of the scanner 3 (step S103), the process proceeds to step S106. On the other hand, when an operation of the scan button 38 is not detected even after a lapse of a certain period of time from the establishment of the session in step S102 (step S104), the first session managing unit 441 discards the session established in step S102 (step S105). Subsequently, the process proceeds to step S120.

In steps S120 and S121, a session is reestablished in response to the operation of the scan button 38. When an operation of the scan button 38 is accepted by the user operation accepting unit 42 of the scanner 3 (step S120), since the session established in step S102 has already been discarded, the first session managing unit 441 performs communication for starting a session with the server 1 and reestablishes a session with the server 1 (step S121). Subsequently, the process proceeds to step S106.

In step S106, a notification of a start of a scan is made. When it is detected that the scan button 38 has been operated, the communication control unit 44 notifies the server 1 that a scan is to be started. Upon receiving the notification, the server 1 makes a transition to an image data waiting state and transmits a response to the scanner 3. By receiving the response transmitted from the server 1, the scanner 3 acknowledges that the notification of the start of the scan has been normally received by the server 1.

When a session is established for each communication as is conventional, a time-lag for establishing a session occurs between the operation of the scan button 38 and the notification of the start of the scan. However, with the system according to the present embodiment, since a session has already been established immediately after an original document is set, such a time-lag does not occur. In addition, according to the present embodiment, a process of terminating the session after receiving the response from the server 1 also need not be performed. Subsequently, the process proceeds to step S107.

In steps S107 and S108, a read setting of the scanner 3 is acquired and reading of an original document is started. Upon receiving the response from the server 1, the communication control unit 44 makes a request for a read setting to the server 1. The read setting requested at this point is a setting having been set in advance by the user for specifying parameters including a resolution during reading by the scanner 3, whether image data is color or monochromatic, color depth, and quality (compression ratio or the like) of image data. The server 1 receives this request and transmits a read setting having been set in advance and retained in the server 1 to the scanner 3. The scanner 3 receives the read setting transmitted from the server 1 (step S107).

When a session is established for each communication as is conventional, a time-lag for establishing a session occurs before a request for a read setting is transmitted. However, with the system according to the present embodiment, since a session is not discarded and remains in an established state even after the notification of the start of the scan is completed in step S106, such a time-lag does not occur. In addition, according to the present embodiment, a process of terminating the session after receiving the read setting from the server 1 also need not be performed. Subsequently, the communication control unit 44 instructs the image data acquiring unit 43 to start reading the original document (step S108).

The process described in steps S109 to S112 is an image data acquisition process by the image data acquiring unit 43, and the process described in steps S113 and S114 is an image data saving process by the communication control unit 44. The image data acquisition process and the image data saving process are executed in parallel.

The image data acquiring unit 43 acquires image data (for example, a file in Joint Photographic Experts Group (JPEG) format) of an original document by sending the original document to the imaging unit 37 using the sheet feeder 36 and having the imaging unit 37 perform imaging of the original document (step S110). In this case, the scanner 3 performs an imaging process (acquisition of image data) according to the read setting acquired in step S107. The acquired image data is saved in an image area of the RAM 33 (step S111).

The process from steps S109 to S111 is repeated until reading of all original documents is finished (step S112). When reading of all original documents is finished, the image data acquisition process ends. Moreover, a trigger for determining that reading of all original documents has been finished may differ depending on the type of the scanner. For example, a determination that reading of all original documents has been finished may be made when the original document sensor 39 detects that the original documents set on the sheet feeder 36 have run out or a determination that reading of all original documents has been finished may be made when a prescribed operation (for example, an operation of the scan button 38) by the user is accepted.

In parallel with the image data acquisition process, the communication control unit 44 reads out image data from the image area of the RAM 33 (step S113). In addition, the communication control unit 44 transmits the acquired image data to the image data processing server 1 (step S114). The image receiving unit 24 of the image data processing server 1 receives the image data transmitted from the scanner 3. In addition, the server 1 saves the received image data. Once saving of the image data is completed by the server 1, a completion notification is transmitted from the result notifying unit 29 of the server 1 to the communication control unit 44 of the scanner 3. The process of steps S113 and S114 is repeated until transmission of image data of all original documents is finished (step S115).

When a session is established and terminated for each transmission of image data as are conventional, a time-lag for establishing a session occurs at each transmission of image data. However, with the system according to the present embodiment, since a session is already established before the start of transmission of each piece of image data and remains in an established state without being discarded even after transmission ends, such a time-lag does not occur. Once transmission of image data of all original documents is finished, the process proceeds to step S116.

In step S116, a notification of an end of the scan is made. When it is detected that imaging of all original documents and transmission of all image data have been finished, the communication control unit 44 notifies the server 1 that the scan has finished. By receiving the notification, the server 1 acknowledges that all image data has been received and transmits a response to the scanner 3. Moreover, the server 1 collectively handles one or a plurality of pieces of image data saved until receiving the notification of the end of the scan as one document (for example, one Portable Document Format (PDF) file). By receiving the response transmitted from the server 1, the scanner 3 acknowledges that the notification of the end of the scan has been normally received by the server 1.

When a session is established for each communication as is conventional, a time-lag for establishing a session occurs before a notification of an end of a scan is transmitted. However, with the system according to the present embodiment, since a session is not discarded and remains in an established state even after the transmission of all image data is finished, such a time-lag does not occur. In addition, according to the present embodiment, a process of terminating the session after receiving the response from the server 1 also need not be performed. Subsequently, the process proceeds to step S117.

In step S117, device information is updated. Once the notification of the end of the scan is completed, the communication control unit 44 transmits contents of an update of device information to the server 1. The device information updated at this point is information related to a device state of the scanner 3 such as a version of firmware of the scanner 3, the total number of pages scanned by the scanner 3, and a remaining battery charge. The server 1 receives the update contents, updates the device information of the scanner 3 retained by the server 1 in accordance with the update contents, and transmits a response to the scanner 3. By receiving the response transmitted from the server 1, the scanner 3 acknowledges that the update contents of the device information have been normally received by the server 1.

When a session is established for each communication as is conventional, a time-lag for establishing a session occurs before update contents of device information are transmitted. However, with the system according to the present embodiment, since a session is not discarded and remains in an established state even after the notification of the end of the scan is completed, such a time-lag does not occur. Subsequently, the process proceeds to step S118.

In steps S118 and S119, the session is discarded after waiting for a prescribed period of time to lapse. When a prescribed period of time (in the present embodiment, 1 minute) lapses without the detection of any operation by the user after the update of the device information is finished (step S118), the first session managing unit 441 discards the session (step S119). In this case, for example, operations of the user include setting an original document on the sheet feeder and operating the scan button 38. In the image data acquisition/saving process, transmission and reception of data for updating the device information are transmission and reception to be performed last among transmission and reception of information for completing the image data acquisition/saving process. When the session is discarded, the process shown in the present flowcharts is finished. On the other hand, when any operation by the user is detected, the session is maintained and communication is performed between the server 1 and the scanner 3 based on the operation by the user using the session. For example, when setting of an original document on the sheet feeder is detected, the process proceeds to step S103 and image data is acquired and saved using the already-established session.

Moreover, in the present embodiment, transmission of image data by the communication control unit 44 is executed following the acquisition of the image data without involving operations by the user other than an operation of the scan button 38.

<Advantageous Effects>

FIG. 7 is a diagram showing time related to establishing sessions and transmitting and receiving data when the image data acquisition/saving process according to the present embodiment is executed. As described above, with the system presented in the present embodiment, by executing a session establishment process immediately after an original document is set by a user, establishment of a session can be completed before accepting an instruction by the user and data transfer can be promptly started without making the user conscious of a waiting time. In addition, in the present embodiment, since data transmission and reception with the server 1 is continued after the establishment of the session in a state where the session is maintained, a period of time for reestablishing a session is not required. Furthermore, in the present embodiment, since a session is discarded once a determination that the session is no longer required is made, a period of time for unnecessarily maintaining a session is reduced and a load on the server 1 can be suppressed.

Moreover, according to the present embodiment, by having a separate system handle processes other than an image data acquisition/saving process (for example, an existence confirmation process), performance of the image data acquisition/saving process which is a primary function of the scanner 3 and which is a portion directly linked to user experience can be relatively improved. In addition, since timings at which the existence confirmation process necessitates communication are intermittent and the communication does not affect the performance of the image data acquisition/saving process, by establishing and discarding sessions as needed without maintaining the sessions, the load on the server 1 can be suppressed.

As described above, according to the present embodiment, both improvements with respect to performance issues of a client and improvements with respect to performance issues of the server 1 can be achieved in various respects.

Moreover, while an example where the scanner 3 is used as an information processing device has been described in the present embodiment, the information processing device may be devices of other types which communicate with a server 1 via a network. For example, the information processing device according to the present invention may be imaging devices of other types such as a camera or devices such as a personal computer. In addition, while an example where data transmitted to a server 1 is image data has been described in the present embodiment, the data transmitted to the server 1 may be data of other types.

1: An information processing device comprising:
a processor configured to establish a session to be established for communication, related to a first process, with a server before an instruction of a start of an imaging operated by a user related to the first process is accepted; and
the processor configured to establish a session to be established for communication, related to a second process, with the server at the same time as or after start of execution of the second process.

2: The information processing device according to claim 1, wherein
the processor maintains the established session while a plurality of communications included in the first process are being performed intermittently.

3: The information processing device according to claim 2, wherein
the first process includes transmission and reception of information of a plurality of different types for completing the first process, and
the processor maintains the established session while a plurality of communications for transmitting and receiving the information of a plurality of different types are being performed intermittently.

4: The information processing device according to claim 3, wherein
after a certain period of time lapses in a state where an operation related to the first process is not detected after end of last transmission and reception included in the transmission and reception of the information of a plurality of different types for completing the first process, the processor discards the session for communication related to the first process.

5: The information processing device according to claim 1, wherein
the processor establishes the session before an instruction by a user related to the first process is accepted and upon detecting that preparation for the first process is being performed by the user.

6: The information processing device according to claim 1, wherein
the information processing device is an imaging device and the first process includes a process of transmitting image data obtained by imaging.

7: The information processing device according to claim 6, wherein
triggered by detecting setting of an imaging object by the user, the processor establishes the session.

8: The information processing device according to claim 1, wherein
the processor discards a session for communication related to the second process at each end of communication included in the second process or at each lapse of time set for each established session.

9: An image data processing method operating a computer to execute:
establishing a session to be established for communication, related to a first process, with a server before an instruction of a start of an imaging operated by a user related to execution of the first process is accepted; and
establishing a session to be established for communication, related to a second process, with the server at the same time as or after start of execution of the second process.

10: An computer-readable non-transitory medium on which is recorded an image data processing program causing a computer to function as:
a first session managing unit to establish a session to be established for communication, related to a first process, with a server before an instruction of a start of an imaging operated by a user related to the first process is accepted; and
a second session managing unit to establish a session to be established for communication, related to a second process, with the server at the same time as or after start of execution of the second process.
